(19) United States
(12) Patent Application Publication
(10) Pub. No.: US 2013/0290093 A1
(43) Pub. Date: Oct. 31, 2013

(54) SYSTEM AND METHOD FOR ESTIMATING THE VALUE OF DISPLAY ADVERTISING

(71) Applicants: Preston MCAFEE, San Marino, CA (US); Daniel Goldstein, New York, NY (US); Siddharth Suri, Brooklyn, NY (US)

(72) Inventors: Preston MCAFEE, San Marino, CA (US); Daniel Goldstein, New York, NY (US); Siddharth Suri, Brooklyn, NY (US)

(73) Assignee: Yahoo! Inc., Sunnyvale, CA (US)

(21) Appl. No.: 13/458,343

(22) Filed: Apr. 27, 2012

(51) Int. Cl. G06Q 30/02

(52) U.S. Cl. 705/14.44

(57) ABSTRACT

A system and method which allow estimation of the value of display advertising are disclosed. Access is provided to a simulated web browsing experience to a plurality of users on a browser on the users' computers. The users have agreed to act as test subjects in exchange for financial compensation. At least one web page comprising a randomly selected article and at least one advertisement is presented to the users. After a predetermined duration, a questionnaire including questions relating to the at least one advertisement is presented to the users. The users are provided with financial compensation for answering the questions.

### BACKGROUND

Display advertising is a multi-billion dollar industry that has traditionally used a pricing scheme based on the number of impressions delivered (i.e., one impression is one download of an ad). One impression, however, does not differentiate between an ad that is in view for five seconds or five minutes. Since advertisers seek brand (and therefore, advertisement) recognition and recall, impression based schemes may not fully align with advertisers' goals. Brand (and advertisement) recognition and recall are a measure of advertising effectiveness in which a sample of respondents is exposed to an ad and then at a later point in time are asked if they remember seeing and/or recognize the ad.

These impressions are typically sold in “guaranteed contracts”, which specify a number of impressions and a set of targeting variables, for example 10 million impressions on auto-related pages sold to women between 30 and 50 years of age, or 7 million impressions targeted to people interested in women's fashion. In addition, display ads are also sold in exchanges like Google's DoubleClick exchange (GDC) or Yahoo!'s Right Media ex-change (RMX). In these exchanges display ads can be individually targeted to specific users, and when a user clicks on a page, the exchange sells the right to show an ad to that particular user as that page loads.

With the advent of web technologies such as AJAX, the practice of tying impressions to the loading of a page is becoming less common. For example, popular email programs like Yahoo! Mail and Gmail update content as new mail comes in without any action by the user. In this dynamic setting a web browser can remain on one URL or page, but the entire content of that page can change at any given time. Thus it is unclear what it means for a page to be replaced, and consequently when an advertisement should be replaced by a subsequent advertisement, because content is replaced in an approximately continuous manner.

An alternative to selling display ads based on impressions is to sell them based on time. Whether advertisements are sold by impressions or by the amount of time spent on the page requires a metric that most closely approximates advertiser value, because this induces the efficient use of resources.

Techniques are needed to facilitate measurement of the causal impact of advertisement exposure time on advertisement recognition and recall, and thus estimate the effectiveness and value of an advertisement.

### SUMMARY

Some embodiments of the invention provide a system and method for estimating the value of display advertising. Access to a simulated web browsing experience may be provided to a plurality of users via a browser on the users' computers, wherein the simulated web browsing experience comprises at least one web page and wherein the users are acting as test subjects in exchange for financial compensation. One example of a simulated web browsing experience may be provided using the Mechanical Turk platform developed by Amazon.

The at least one web page may be presented to the users, wherein the at least one web page comprises a randomly selected article and at least one advertisement that is displayed on the webpage for a predetermined duration. The advertisement may be displayed for the amount of time it takes the user to read the article. The webpage may contain a link that the user may click when the user is finished reading the article. Alternatively, the advertisement may be displayed for a fixed duration, such as 60 seconds. The location, content and number of advertisements may also be varied.

At the end of the predetermined duration, a questionnaire may be presented to the users, wherein the questionnaire comprises questions relating to the at least one advertisement. The questionnaire may include questions such as “Which advertisements, if any, did you see on the page during the experiment? Type the name of any advertisers here if you can remember seeing their ads on the last page, or indicate that you are unable to remember any.” In addition, they may be asked “Did you see the following advertisement during this HIT?” accompanied by a picture of the ad that was shown. The same question may also be asked accompanied by a picture of an ad that was not shown (referred to as a lure), to establish a false alarm rate. Users may be provided financial compensation for answering the questions in addition to the compensation that was provided for participating in the HIT. The additional payment may be tied to the number of questions answered.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention.

### DETAILED DESCRIPTION

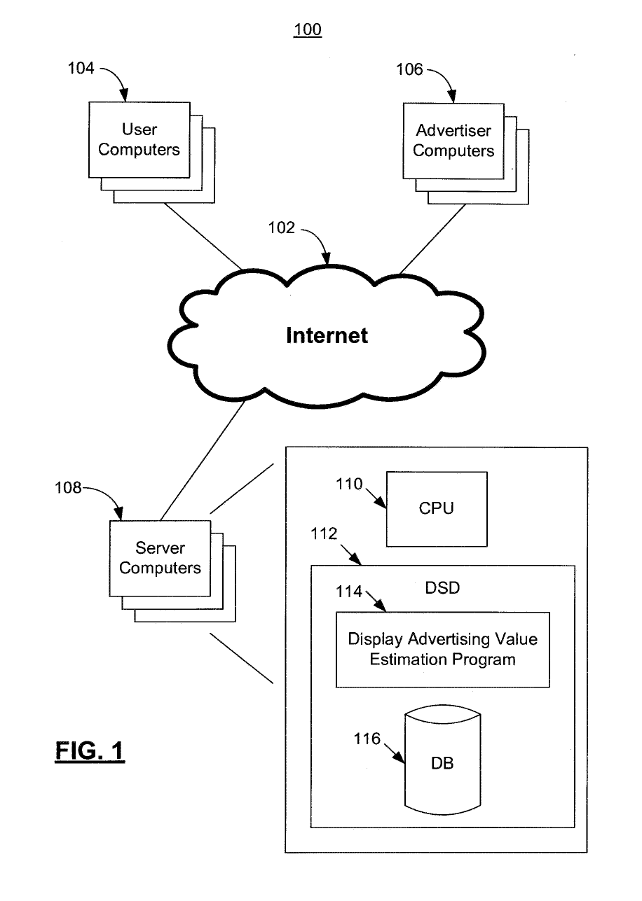

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as cell phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Display Advertising Value Estimation Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

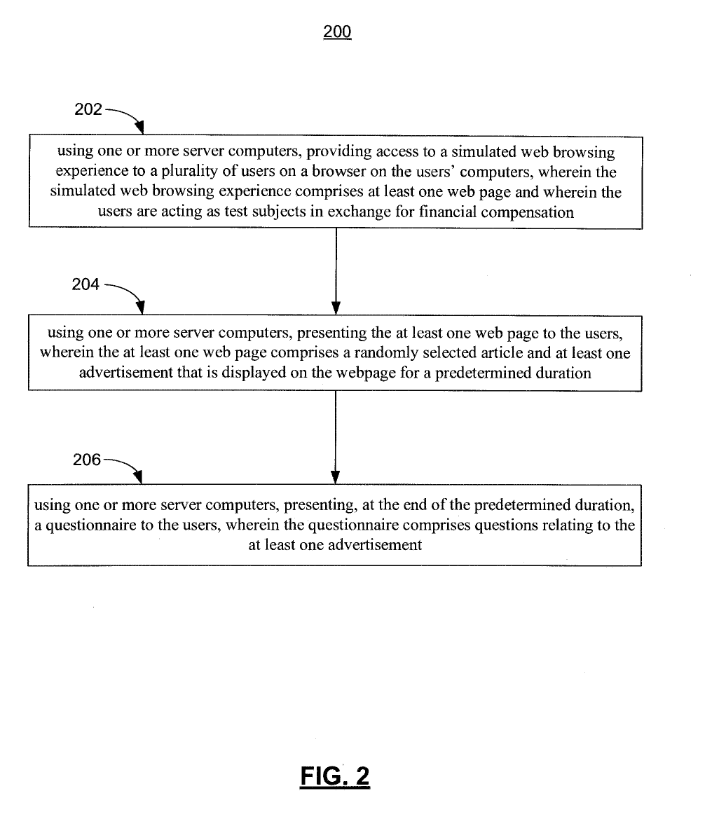

FIG. 2 is a flow diagram illustrating a method 200 according to one embodiment of the invention. At step 202, using one or more server computers, access to a simulated web browsing experience may be provided to a plurality of users via a browser on the users' computers, wherein the simulated web browsing experience comprises at least one web page and wherein the users are acting as test subjects in exchange for financial compensation. One example of a simulated web browsing experience may be provided using the Mechanical Turk platform developed by Amazon. The Amazon Mechanical Turk (MTurk) is a crowdsourcing website that enables requesters to co-ordinate the use of human intelligence to perform tasks that computers are unable to do yet. The requesters are able to post tasks known as HITs (Human Intelligence Tasks), such as choosing the best among several photographs of a store-front, extracting data from images, audio transcription and filtering adult content. Workers can then browse among existing tasks and complete them for a monetary payment set by the requester. After a worker submits their work for a HIT, requesters review the work and may accept it or reject it. To place HITs, the requesting programs use an Application Programming Interface (API). Requesters may use the API to restrict the pool of workers that may complete a HIT by specifying for example, that workers live in the US and have an approval rating of over 90%.

At step 204, using one or more server computers, the at least one web page may be presented to the users, wherein the at least one web page comprises a randomly selected article and at least one advertisement that is displayed on the webpage for a predetermined duration. The advertisement may be displayed for the amount of time it takes the user to read the article. The webpage may contain a link that the user may click when the user is finished reading the article. Alternatively, the advertisement may be displayed for a fixed duration, such as 60 seconds.

At step 206, using one or more server computers, at the end of the predetermined duration, a questionnaire may be presented to the users, wherein the questionnaire comprises questions relating to the at least one advertisement. The questionnaire may include questions such as “Which advertisements, if any, did you see on the page during the experiment? Type the name of any advertisers here if you can remember seeing their ads on the last page, or indicate that you are unable to remember any.” In addition, they may be asked “Did you see the following advertisement during this HIT?” accompanied by a picture of the ad that was shown. The same question may also be asked accompanied by a picture of an ad that was not shown (referred to as a lure), to establish a false alarm rate. Users may be provided financial compensation for answering the questions in addition to the compensation that was provided for participating in the HIT. The additional payment may be tied to the number of questions answered. It should be noted that payment is not based on the correctness of the answers to avoid the possibility of collusion.

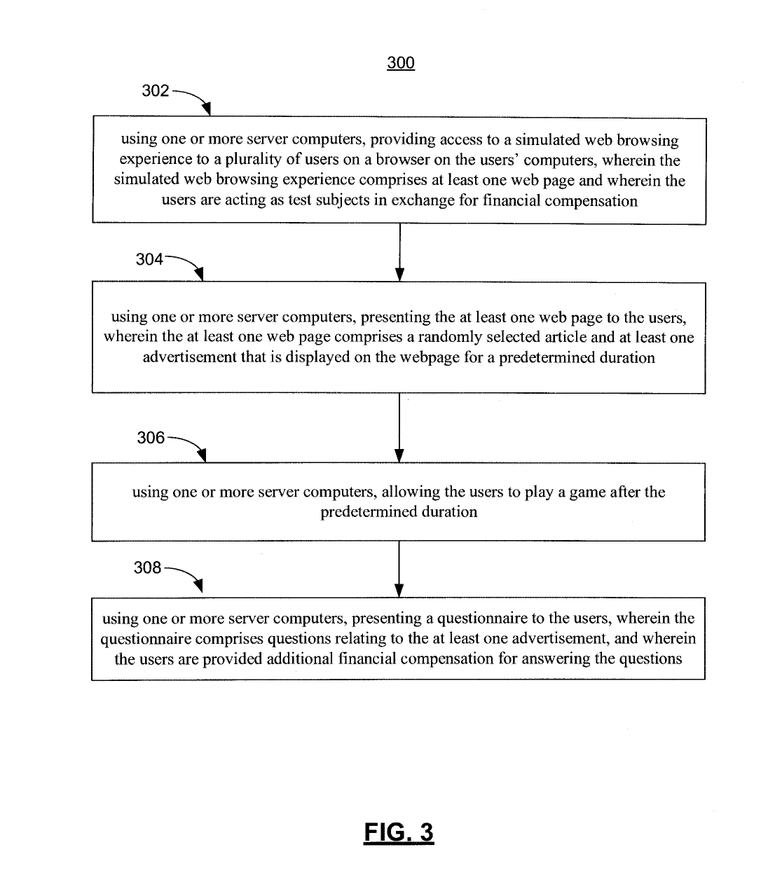

FIG. 3 is a flow diagram illustrating a method 300 according to one embodiment of the invention. At step 302, using one or more server computers, access to a simulated web browsing experience may be provided to a plurality of users via a browser on the users' computers, wherein the simulated web browsing experience comprises at least one web page and wherein the users are acting as test subjects in exchange for financial compensation. As discussed above in connection with the description of FIG. 2, a platform such as Amazon Mechanical Turk may be used to provide the simulated web browsing experience.

At step 304, using one or more server computers, the at least one web page may be presented to the users, wherein the at least one web page comprises a randomly selected article and at least one advertisement that is displayed on the webpage for a predetermined duration.

At step 306, using one or more server computers, the users may be allowed to play a game after the predetermined duration. To stabilize forgetting time across participants, the reading task may be followed by a buffer task in which participants play a game. For example, the users may play Tetris, a visual game consisting of primary shapes, which is chosen to avoid ad-specific linguistic memory interference. The game may be rendered in black and white to reduce visual memory interference with the colors present in the ads. After the buffer task time expires, participants are automatically forwarded to the questionnaire, and are not able to exit the game early.

At step 308, using one or more server computers, a questionnaire may be presented to the users, wherein the questionnaire comprises questions relating to the at least one advertisement, and wherein the users are provided additional financial compensation for answering the questions. As discussed above, the users may be asked questions relating to ad recall and ad recognition. The users are provided financial compensation per question answered, where payment is not based on the correctness of the answers.

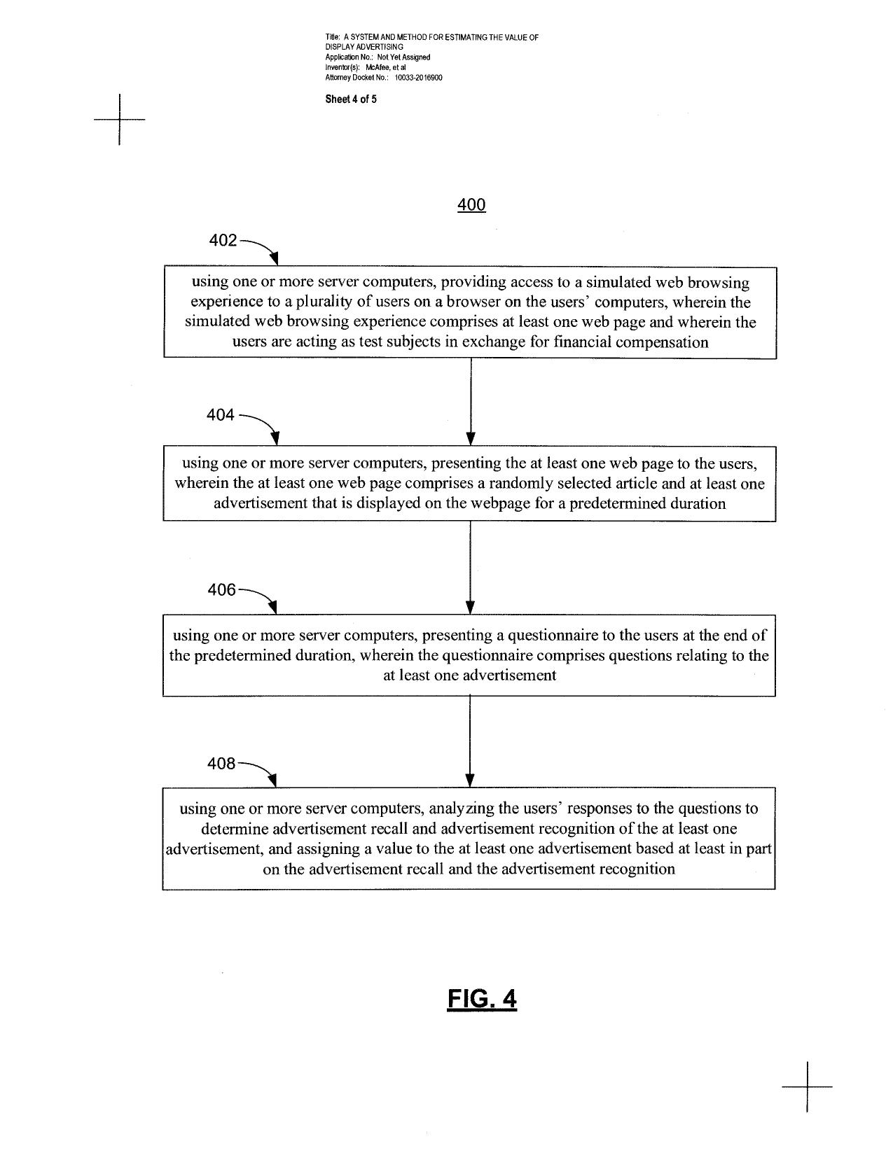

FIG. 4 is a flow diagram illustrating a method 400 according to one embodiment of the invention. At step 402, using one or more server computers, access to a simulated web browsing experience may be provided to a plurality of users via a browser on the users' computers, wherein the simulated web browsing experience comprises at least one web page and wherein the users are acting as test subjects in exchange for financial compensation. At step 404, using one or more server computers, the at least one web page may be presented to the users, wherein the at least one web page comprises a randomly selected article and at least one advertisement that is displayed on the webpage for a predetermined duration.

At step 406, using one or more server computers, a questionnaire may be presented to the users at the end of the predetermined duration, wherein the questionnaire comprises questions relating to the at least one advertisement. At step 408, using one or more server computers, the users' responses to the questions may be analyzed to determine advertisement recall and advertisement recognition of the at least one advertisement, and a value may be assigned to the at least one advertisement based at least in part on the advertisement recall and the advertisement recognition. In other words, effectiveness of the advertisement may be determined based at least in part on the responses to the questions and monetary value may be assigned to the advertisement based on the effectiveness and the exposure time.

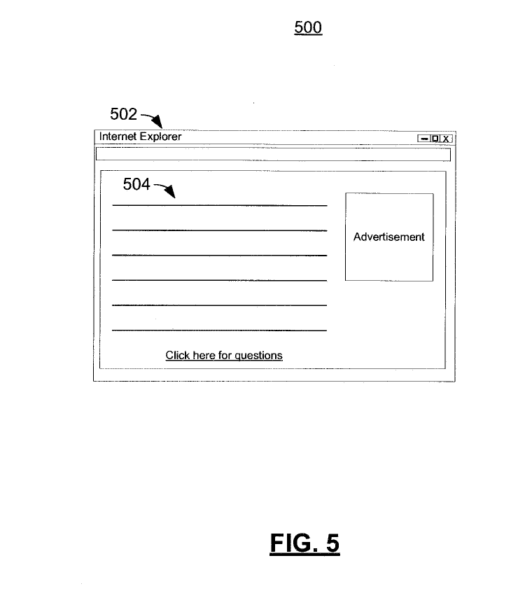

FIG. 5 is a block diagram 500 illustrating one embodiment of the invention. A screenshot of a website 502 in accordance with one embodiment of the invention is depicted. As shown, the website includes an article 504 and an advertisement. The article may be a single page or multiple page article. As discussed above, participants or users may be provided access to a simulated web browsing experience via a browser on their computer. The simulated web browsing experience may be provided using, for example, Amazon Mechanical Turk. The simulated web browsing experience may be used to conduct experiments by varying article length, content, advertisement exposure time, advertisement placement location on the webpage, advertisement content, etc. to determine, for example, advertisement effectiveness, the affect of advertisement exposure time on advertisement recall and recognition, etc. These factors may then be used to determine a value for the advertisement, which may be used by sellers in selling the advertisement. Examples of experiments that were conducted using this process will now be described below.

Participants were recruited from Mechanical Turk by means of a HIT offering a fixed payment in addition to a smaller payment per question answered (to avoid the possibility of collusion, payment was not based on the correctness of answers). The preview page for the HIT consisted of a consent form and instructions indicating that the task involved reading and answering questions about a Web page. In order to spread out the distribution of reading times, participants were assigned to conditions in which the article was either short or long. Randomization occurred at the moment the HIT was undertaken, precluding any confound between time of testing and condition assignment. In addition to article length, random assignment also governed which of two display ads (for either Netflix or Jeep) and which of two articles (about either schoolteachers or an oil spill) would be shown.

In the task, participants were shown screen captures of web pages, as shown in FIG. 5. Although the display ad is shown next to the text of the article, the advertisement may be displayed anywhere on the webpage depending on the experiment being conducted.

After reading the first page of their assigned article, participants clicked a button to continue on to a second page, which featured the same display ad as the first page. In the case of the short article, the second page contained only one sentence, while in the long article the text extended to the bottom of the second page. After the participants read both pages at their own pace, they proceeded on to the questionnaire and were unable to direct the browser to display the ad or article again. The questionnaire first presented two, five-alternative multiple choice reading comprehension questions. After that, it presented one unaided recall question: “Which advertisements, if any, did you see on the page during the experiment? Type the name of any advertisers here if you can remember seeing their ads on the last page, or indicate that you are unable to remember any.” On a subsequent page, participants were asked “Did you see the following advertisement during this HIT?”, accompanied by a picture of the Netflix ad, and were then presented the same question for the Jeep ad. Note that participants were shown only one of these two ads in the experiment, making the other ad a lure which is useful for establishing the false alarm rate.

Each participants' questionnaire responses were coded as four binary items. The first two binary items coded whether the unaided recall question mentioned the two advertisements. The latter two binary items coded the pictorial recognition task.

In the experiment described previously the exposure time of the advertisement was determined by the participants' reading time. Because the experimental manipulation of ad exposure depended on a participants reading speed, it is difficult to conclude a causal reason for the variation in recognition and recall rates.

Another experiment was conducted to alleviate this issue by externally imposing an exposure time on the participant. This allowed determination of if there was a causal link between the time of ad exposure and recall and recognition rates.

Whereas in the first experiment, ad exposure time was roughly equivalent to reading time, this experiment manipulated exposure time exogenously to estimate the causal effect of ad exposure time on memory. This was accomplished by displaying ads for a pre-determined number of seconds while people are reading and then having them disappear from view. Instructions again indicated that the task involved reading and answering questions about a Web page. Participants were again paid a flat rate for completing the experiment, plus a specified amount per question answered. Participants were randomly assigned into one of four conditions which governed how long they were exposed to the display ad. Simultaneous with the loading of the article, an ad was displayed, depending on condition, for either 5, 10, 25, or 40 seconds. These initial advertisements were then replaced with second ads, which were displayed for 25, 40, 5, or 10 seconds in the respective conditions. For example, if the first ad displayed for 5 seconds, the second was displayed for 25 seconds, and if the first ad was displayed for 10 seconds, the second ad was displayed for 40 seconds. After the display time for the second ad expired it was replaced with a white rectangle, giving the appearance of it disappearing altogether.

To stabilize forgetting time across participants, the reading task was followed by a buffer task such as for example, playing a game for an amount of time that depended on condition. Tetris, a visual game consisting of primary shapes, was chosen to avoid ad-specific linguistic memory interference. The game was rendered in black and white to reduce visual memory interference with the colors present in the ads. Buffer task duration was calculated to equalize forgetting time for the average participant in each condition and ranged between 20 and 55 seconds. After the buffer task time expired, participants were automatically forwarded to the questionnaire, and were not able to exit the game early.

In the questionnaire phase, the same two, five-alternative multiple choice reading comprehension questions were asked followed by the same unaided recall question as in the first experiment. A subsequent page presented four recognition questions with textual cues of the form “Did you see a Netflix ad?”, with Jeep, American Express and Avis as the other advertisers. Netflix and Jeep were the “target” advertisers whose ads that participants were indeed shown, while American Express and Avis were “lure” advertisers, whose advertisements were not shown. Inclusion of lures was particularly relevant for the next four questions, which were recognition questions with pictorial cues asking “Did you see this ad?” and showing the two ads from the experiment and two lures. The lures were chosen for bearing a strong visual resemblance to the targets. For example, the Avis lure is primarily red, much like the Netflix ad and the American Express ad has a very similar color scheme to the Jeep ad.

Results of the experiments were able to establish a causal effect of exposure time on ad recall and ad recognition. More specifically, it was shown that ad recognition and recall increase as exposure time increases, with the steepest effect occurring for low values of exposure time. The secondary result was that only the first ad shown has this steep increase of recognition and recall in the first few seconds, but both the first and second ad shown benefit from more exposure time.

As mentioned in the Background section, display ads are currently sold by impressions. This pricing scheme charges all users the same, independent of the amount of time users spend with an ad in view. Advertisers value ad recognition and ad recall, and time of exposure directly impacts both. Pricing based on better measures of actual advertiser value, as opposed to an average over a set of items or a noisy measure of value, offers three distinct advantages. First, it permits efficient allocation. When pricing is based on an average, allocating pieces to different buyers is impossible, since the pieces have the same average value. Similarly, with noisy measures of value, more allocative mistakes will be made. Second, pricing based more closely on value mitigates buyer risk, since pricing corresponds more closely to the value actually delivered. Risk matters most in environments with great supply variability like digital advertising. Finally, pricing based on value permits price discrimination-charging advertisers based on the value delivered may let the seller capture a larger fraction of the value generated.

While embodiments of the invention are described with reference to the above drawings, the drawings are intended to be illustrative, and the invention contemplates other embodiments within the spirit of the invention.

1. A method comprising:
using one or more server computers, providing access to a simulated web browsing experience to a plurality of users on a browser on the users' computers, wherein the simulated web browsing experience comprises at least one web page and wherein the users are acting as test subjects in exchange for financial compensation;
using one or more server computers, presenting the at least one web page to the users, wherein the at least one web page comprises a randomly selected article and at least one advertisement that is displayed on the webpage for a predetermined duration; and
using one or more server computers, presenting, at the end of the predetermined duration, a questionnaire to the users, wherein the questionnaire comprises questions relating to the at least one advertisement.

2. The method of claim 1, further comprising:
using one or more server computers, providing additional financial compensation to the users for answering the questions in the questionnaire.

3. The method of claim 1, wherein the at least one advertisement is randomly selected.

4. The method of claim 1, wherein the questionnaire comprises at least one question relating to recall of the advertisement and recognition of the advertisement.

5. The method of claim 1, wherein the predetermined duration corresponds to the amount of time it takes a user to read the article.

6. The method of claim 1, wherein the advertisement is displayed adjacent to text of the article.

7. The method of claim 1, wherein the predetermined duration is a fixed duration.

8. The method of claim 7, further comprising:
using one or more server computers, displaying a second advertisement at the end of the fixed duration.

9. The method of claim 1, wherein the predetermined duration is randomly selected.

10. A system comprising:
one or more server computers coupled to a network; and
one or more databases coupled to the one or more server computers;
wherein the one or more server computers are for:
providing access to a simulated web browsing experience to a plurality of users on a browser on the users' computers, wherein the simulated web browsing experience comprises at least one web page and wherein the users are acting as test subjects in exchange for financial compensation;
presenting the at least one web page to the users, wherein the at least one web page comprises a randomly selected article and at least one advertisement that is displayed on the webpage for a predetermined duration; and
presenting, at the end of the predetermined duration, a questionnaire to the users, wherein the questionnaire comprises questions relating to the at least one advertisement.

11. The system of claim 10, wherein the one or more server computers are further configured for:
providing additional financial compensation to the users for answering the questions in the questionnaire.

12. The system of claim 10, wherein the at least one advertisement is randomly selected.

13. The system of claim 10, wherein the questionnaire comprises at least one question relating to recall of the advertisement and recognition of the advertisement.

14. The system of claim 10, wherein the predetermined duration corresponds to the amount of time it takes a user to read the article.

15. The system of claim 10, wherein the advertisement is displayed adjacent to text of the article.

16. The system of claim 10, wherein the predetermined duration is a fixed duration.

17. The system of claim 16, wherein the one or more server computers are further configured for:
displaying a second advertisement at the end of the fixed duration.

18. The system of claim 10, wherein the predetermined duration is randomly selected.

19. The system of claim 10, wherein the one or more server computers are further configured for:
allowing the users to play a game before presenting the questionnaire to the users.

20. A computer readable medium or media containing instructions for executing a method comprising:
using one or more server computers, providing access to a simulated web browsing experience to a plurality of users on a browser on the users' computers, wherein the simulated web browsing experience comprises at least one web page and wherein the users are acting as test subjects in exchange for financial compensation;
using one or more server computers, presenting the at least one web page to the users, wherein the at least one web page comprises a randomly selected article and at least one advertisement that is displayed on the webpage for a predetermined duration;
using one or more server computers, allowing the users to play a game after the predetermined duration; and
using one or more server computers, presenting a questionnaire to the users, wherein the questionnaire comprises questions relating to the at least one advertisement, and wherein the users are provided additional financial compensation for answering the questions.
